(19) United States
(12) Patent Application Publication
(10) Pub. No.: US 2026/0370961 A1
(43) Pub. Date: Nov. 19, 2026

(54) Systems and Methods for Direct Convolutional Training and Inference for Image Processing of Color Mosaic Camera Sensors

(71) Applicant: Google LLC, Mountain View, CA (US)

(72) Inventors: Alex Joseph Bewley, Zurich (CH); David Bryan D'Ambrosio, Atlanta, GA (US); Navdeep Jaitly, Cupertino, CA (US)

(21) Appl. No.: 19/487,363

(22) PCT Filed: May 23, 2024
(86) PCT No.: PCT/US2024/030788

§ 371 Date: Nov. 25, 2025

Related U.S. Application Data
(60) Provisional application No. 63/504,768, filed on May 29, 2023.

(51) Int. Cl. H04N 23/88

(52) U.S. Cl. CPC H04N 23/88

(57) ABSTRACT

An example method includes receiving, by an input layer of a neural network, a pre-training dataset comprising a plurality of images, each image of the plurality of images comprises image data in an initial color system; generating a training dataset by converting each image of the plurality of images to a respective image comprising image data arranged in a color filter array that corresponds to an arrangement of color filters on a grid of photosensors; training the neural network by aligning a stride of an input receptive field of the input layer to match an input grid stride for the color filter array, the stride of the input receptive field corresponds to a number of pixel shifts over the color filter array, and performing, based on the aligned stride, the image processing on one or more images of the generated training dataset; and providing the trained neural network.

### CROSS-REFERENCE TO RELATED APPLICATIONS/INCORPORATION BY REFERENCE

This application claims priority to U.S. Provisional Patent Application No. 63/504,768, filed on May 29, 2023, which is hereby incorporated by reference in its entirety.

### BACKGROUND

Digital image sensors in digital imaging devices include various filters to arrange input colors onto a grid of photosensors. Neural networks can be used to process the raw data captured by the photosensors.

### SUMMARY

Mosaic sensors are used to capture raw data. A neural network can be used to process this data. This may require some application of striding and alignment to prevent the convolution from losing color information, and/or requiring an excessively large number of filters to maintain mosaic response patterns for the neural network to discern in later layers.

Performing image processing on raw mosaic images can result in considerable savings of computing resource and memory bound platforms, and can also save on latency. This is primarily due to reduction of the image size to a third as compared to the RGB images.

Accordingly, there is a need for a neural network with an input layer that can take input raw data and efficiently output image data that can be used for downstream image processing applications. A reduced size of the output data can also enhance transmission and/or storage of the data.

In one aspect, a computer-implemented method of training a neural network for image processing is provided. The method includes receiving, by an input layer of the neural network, a pre-training dataset comprising a plurality of images, wherein each image of the plurality of images comprises image data in an initial color system. The method also includes generating, by the input layer of the neural network, a training dataset from the pre-training dataset, wherein the generating comprises converting each image of the plurality of images to a respective image comprising image data arranged in a color filter array, and wherein the color filter array corresponds to an arrangement of color filters on a grid of photosensors corresponding to a camera sensor. The method additionally includes training the neural network based on the generated training dataset by aligning a stride of an input receptive field of the input layer of the neural network to match an input grid stride for the color filter array, wherein the stride of the input receptive field corresponds to a number of pixel shifts over the color filter array, and performing, based on the aligned stride, the image processing on one or more images of the generated training dataset The method further includes providing the trained neural network.

In a second aspect, a computing device is provided. The computing device includes one or more processors and data storage. The data storage has stored thereon computer-executable instructions that, when executed by one or more processors, cause the computing device to carry out functions of training a neural network for image processing. The functions include: receiving, by an input layer of the neural network, a pre-training dataset comprising a plurality of images, wherein each image of the plurality of images comprises image data in an initial color system; generating, by the input layer of the neural network, a training dataset from the pre-training dataset, wherein the generating comprises converting each image of the plurality of images to a respective image comprising image data arranged in a color filter array, and wherein the color filter array corresponds to an arrangement of color filters on a grid of photosensors corresponding to a camera sensor; training the neural network based on the generated training dataset by aligning a stride of an input receptive field of the input layer of the neural network to match an input grid stride for the color filter array, wherein the stride of the input receptive field corresponds to a number of pixel shifts over the color filter array, and performing, based on the aligned stride, the image processing on one or more images of the generated training dataset; and providing the trained neural network.

In a third aspect, a computer program is provided. The computer program includes instructions that, when executed by a computer, cause the computer to carry out functions of training a neural network for image processing. The functions include: receiving, by an input layer of the neural network, a pre-training dataset comprising a plurality of images, wherein each image of the plurality of images comprises image data in an initial color system; generating, by the input layer of the neural network, a training dataset from the pre-training dataset, wherein the generating comprises converting each image of the plurality of images to a respective image comprising image data arranged in a color filter array, and wherein the color filter array corresponds to an arrangement of color filters on a grid of photosensors corresponding to a camera sensor; training the neural network based on the generated training dataset by aligning a stride of an input receptive field of the input layer of the neural network to match an input grid stride for the color filter array, wherein the stride of the input receptive field corresponds to a number of pixel shifts over the color filter array, and performing, based on the aligned stride, the image processing on one or more images of the generated training dataset; and providing the trained neural network.

In a fourth aspect, an article of manufacture is provided. The article of manufacture includes one or more computer readable media having computer-readable instructions stored thereon that, when executed by one or more processors of a computing device, cause the computing device to carry out functions of training a neural network for image processing. The functions include: receiving, by an input layer of the neural network, a pre-training dataset comprising a plurality of images, wherein each image of the plurality of images comprises image data in an initial color system; generating, by the input layer of the neural network, a training dataset from the pre-training dataset, wherein the generating comprises converting each image of the plurality of images to a respective image comprising image data arranged in a color filter array, and wherein the color filter array corresponds to an arrangement of color filters on a grid of photosensors corresponding to a camera sensor; training the neural network based on the generated training dataset by aligning a stride of an input receptive field of the input layer of the neural network to match an input grid stride for the color filter array, wherein the stride of the input receptive field corresponds to a number of pixel shifts over the color filter array, and performing, based on the aligned stride, the image processing on one or more images of the generated training dataset; and providing the trained neural network.

In a fifth aspect, a system to carry out functions training a neural network for image processing is provided. The system includes means for receiving, by an input layer of the neural network, a pre-training dataset comprising a plurality of images, wherein each image of the plurality of images comprises image data in an initial color system; means for generating, by the input layer of the neural network, a training dataset from the pre-training dataset, wherein the generating comprises converting each image of the plurality of images to a respective image comprising image data arranged in a color filter array, and wherein the color filter array corresponds to an arrangement of color filters on a grid of photosensors corresponding to a camera sensor; means for training the neural network based on the generated training dataset by aligning a stride of an input receptive field of the input layer of the neural network to match an input grid stride for the color filter array, wherein the stride of the input receptive field corresponds to a number of pixel shifts over the color filter array, and performing, based on the aligned stride, the image processing on one or more images of the generated training dataset; and means for providing the trained neural network.

In a sixth aspect, a computer-implemented method of applying a trained neural network for image processing is provided. The method includes receiving, by a computing device, input raw image data arranged in a color filter array, wherein the color filter array corresponds to an arrangement of color filters on a grid of photosensors corresponding to a camera sensor. The method also includes applying, by the computing device, the trained neural network for image processing, the neural network having been trained by aligning a stride of an input receptive field of the input layer of the neural network to match an input grid stride for the color filter array for the input raw image data, wherein the stride of the input receptive field corresponds to a number of pixel shifts over the color filter array, and performing, based on the aligned stride, the image processing on a plurality of images of a training dataset, wherein each image of the plurality of images comprises image data in the color filter array. The method also includes performing the image processing on the input raw image data based on the aligned stride of the input receptive field. The method additionally includes providing, by the computing device, the output of the image processing on the input raw image data of the image processing on the input raw image data.

In a seventh aspect, a computing device is provided. The computing device includes one or more processors and data storage. The data storage has stored thereon computer-executable instructions that, when executed by one or more processors, cause the computing device to carry out functions of applying a trained neural network for image processing. The functions include: receiving, by a computing device, input raw image data arranged in a color filter array, wherein the color filter array corresponds to an arrangement of color filters on a grid of photosensors corresponding to a camera sensor; applying, by the computing device, the trained neural network for image processing, the neural network having been trained by aligning a stride of an input receptive field of the input layer of the neural network to match an input grid stride for the color filter array for the input raw image data, wherein the stride of the input receptive field corresponds to a number of pixel shifts over the color filter array, and performing, based on the aligned stride, the image processing on a plurality of images of a training dataset, wherein each image of the plurality of images comprises image data in the color filter array; performing the image processing on the input raw image data based on the aligned stride of the input receptive field; and providing, by the computing device, the providing, by the computing device, the output of the image processing on the input raw image data.

In an eighth aspect, a computer program is provided. The computer program includes instructions that, when executed by a computer, cause the computer to carry out functions of applying a trained neural network for image processing. The functions include: receiving, by a computing device, input raw image data arranged in a color filter array, wherein the color filter array corresponds to an arrangement of color filters on a grid of photosensors corresponding to a camera sensor; applying, by the computing device, the trained neural network for image processing, the neural network having been trained by aligning a stride of an input receptive field of the input layer of the neural network to match an input grid stride for the color filter array for the input raw image data, wherein the stride of the input receptive field corresponds to a number of pixel shifts over the color filter array, and performing, based on the aligned stride, the image processing on a plurality of images of a training dataset, wherein each image of the plurality of images comprises image data in the color filter array; performing the image processing on the input raw image data based on the aligned stride of the input receptive field; and providing, by the computing device, the providing, by the computing device, the output of the image processing on the input raw image data.

In a ninth aspect, an article of manufacture is provided. The article of manufacture includes one or more computer readable media having computer-readable instructions stored thereon that, when executed by one or more processors of a computing device, cause the computing device to carry out functions of applying a trained neural network for image processing. The functions include: receiving, by a computing device, input raw image data arranged in a color filter array, wherein the color filter array corresponds to an arrangement of color filters on a grid of photosensors corresponding to a camera sensor; applying, by the computing device, the trained neural network for image processing, the neural network having been trained by aligning a stride of an input receptive field of the input layer of the neural network to match an input grid stride for the color filter array for the input raw image data, wherein the stride of the input receptive field corresponds to a number of pixel shifts over the color filter array, and performing, based on the aligned stride, the image processing on a plurality of images of a training dataset, wherein each image of the plurality of images comprises image data in the color filter array; performing the image processing on the input raw image data based on the aligned stride of the input receptive field; and providing, by the computing device, the providing, by the computing device, the output of the image processing on the input raw image data.

In a tenth aspect, a system for applying a trained neural network for image processing is provided. The system includes means for receiving, by a computing device, input raw image data arranged in a color filter array, wherein the color filter array corresponds to an arrangement of color filters on a grid of photosensors corresponding to a camera sensor; means for applying, by the computing device, the trained neural network for image processing, the neural network having been trained by aligning a stride of an input receptive field of the input layer of the neural network to match an input grid stride for the color filter array for the input raw image data, wherein the stride of the input receptive field corresponds to a number of pixel shifts over the color filter array, and performing, based on the aligned stride, the image processing on a plurality of images of a training dataset, wherein each image of the plurality of images comprises image data in the color filter array; means for performing the image processing on the input raw image data based on the aligned stride of the input receptive field; and means for providing, by the computing device, the output of the image processing on the input raw image data

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 is a diagram illustrating an example mosaic pattern for image sensor data, in accordance with example embodiments.

FIG. 2 is a diagram illustrating example strides aligned to a mosaic pattern for image sensor data, in accordance with example embodiments.

FIG. 3 is a diagram illustrating an example training phase for a neural network, in accordance with example embodiments.

FIG. 4 is a diagram illustrating an example inference phase for a neural network, in accordance with example embodiments.

FIG. 5 illustrates examples of training patches for ball detector comparisons between various object detection models for a robotic table tennis system, in accordance with example embodiments.

FIG. 6 is a diagram illustrating training and inference phases of a machine learning model, in accordance with example embodiments.

FIG. 7 depicts a distributed computing architecture, in accordance with example embodiments.

FIG. 8 is a block diagram of a computing device, in accordance with example embodiments.

FIG. 9 depicts a network of computing clusters arranged as a cloud-based server system, in accordance with example embodiments.

FIG. 10 is a flowchart of a method, in accordance with example embodiments.

FIG. 11 is a flowchart of another method, in accordance with example embodiments.

### DETAILED DESCRIPTION

This application relates, in one aspect, to training a neural network for image processing of raw image data from an image sensor. In another aspect, this application relates to applying a trained neural network for image processing of raw image data from an image sensor. In particular, this application relates to configuring an input layer of the neural network to align a stride of an input receptive field of the input layer of the neural network to match an input grid stride for a color filter array for the raw image data. The stride of the input receptive field corresponds to a number of pixel shifts over the color filter array.

Convolutional neural networks (CNNs) are a type of deep learning model that are commonly used for various image processing tasks such as recognition, classification, detection, segmentation, and depth estimation and more. The networks are composed of multiple layers, each of which performs a convolution operation on the input data. The convolution operation involves sliding a small window, called a kernel, over the input data, and multiplying the values in the kernel by the values in the input data. The results of these multiplications are then summed together to produce a single output value.

In image processing examples, the input can be a single channel image, or a set of three (3) channel images that includes of red, green and blue (RGB) color channels. Such color images are generally captured with an array of light sensors covered with different color filters that are generally arranged as a repeated mosaic. For low latency and memory bound applications it is sometimes desirable to process such a raw color mosaic image as opposed to some RGB equivalent that was reconstructed from the raw image.

Applying Convolutional Neural Networks (CNNs) to raw data captured from mosaic sensors such as, for example, the Bayer pattern on common color cameras, often includes non-trivial applications of striding and alignment to prevent the convolution from losing color information. Such convolutional operations, when applied to a raw color mosaic, can be sub-optimal if the stride is not a multiple of the input mosaic stride. For example using the default stride of one (1) on a common Bayer pattern may result in the same kernel weight being applied to all colors in the mosaic, as opposed to being applied to a single color, as performed in a multi-channel RGB images. Such use of the standard convolution on mosaics where the color changes by location may effectively destroy a spatial equivariant property of convolutions at a local scale, and can degrade learning, as watch weight is shared across multiple colors. This can result in a potential loss of discriminative information offered from using a color sensor resulting in the ubiquitous application of CNNs on multi-channel color images. In some instances, the CNNs have to be configured with a large number of filters to maintain mosaic response patterns that the network can utilize in subsequent layers.

Processing of raw mosaic images can result in considerable savings on resource and memory bound platforms, and can also save on latency. This is primarily due to a reduction of the image size to a third compared to the commonly used RGB images.

Although some existing CNNs are applied to raw images, these do not consider the inherent structural symmetries of the mosaic and are not aligned to the mosaic pattern. For example, a CNN is either directly to the mosaic (Bayer) image and the alignment is ignored, or a custom de-mosaic operation is performed.

Some existing methods are applied to sample color features for input to a CNN. However, such methods do not describe how to correctly use stride with Bayer images. Also, for example, such methods are not based on aligning the input receptive field of the network to a fixed alignment with the repeated mosaic structure. This is indicated by a low accuracy performance when attempting to use the Bayer image.

### Technical Improvements

The described techniques allow for processing of raw image data. Processing of raw mosaic images can result in considerable savings on resource and memory bound platforms, and can also save on latency. This is primarily due to a direct application of mosaic processing instead of RGB processing, and also a reduction of the image size to a third compared to the commonly used RGB images.

By ensuring that the stride of the first convolutional layer is a multiple of the stride for the input image mosaic pattern, the same kernel weight is always applied for the same color. This enhances learning by the neural network as a weight is no longer shared across multiple colors, thereby preserving discriminative information offered from using a color sensor.

Preserving the color-based discriminative information that is included in a color sensor is especially significant in object detection and tracking, where a color of the object may be known. For example, a robotic table tennis system may use an orange ball, and the described techniques can significantly improve detection, and tracking of the orange ball, thereby enhancing the response time of the robot in near real-time.

The techniques described herein consider the inherent structural symmetries of the mosaic. Also, for example, an output of the network may be applied to multiple downstream tasks. The techniques described herein improve spatial equivariant property of convolutions at a local scale.

In processing of raw mosaic images as inputs to a CNN, common techniques for data augmentation, such as random cropping and color alteration, need to be adapted for the single-channel strided mosaic pattern. For example, color is encoded by its position in the mosaic; accordingly, a cropping operation is performed at a multiple of the mosaic pattern stride. Another aspect relates to color augmentation. Color augmentation may be performed in the described framework via multiple options: (a) convert a raw mosaic to RGB, perform standard color augmentation, and then convert back from RGB to a raw mosaic; (b) generate noise for each unique color in the mosaic, rearrange these values repeated to match the input mosaic, add this to the raw input image, and change the individual color values between batches; and (c) apply color augmentation after the first convolutional layer as the strided and aligned convolution maps the position encoded colors to channel encodings.

A stride greater than one results in down-sampling the spatial resolution. Accordingly, such use of strided convolutions early in a CNN stack saves compute time.

Down-sampling of a spatial resolution can also significantly improve data transfers from the central processing unit (CPU) to the graphics processing unit (GPU).

The techniques described herein enable white-balance correction (e.g., a fixed weighting applied to each color to simulate equal values for white light). In applications where raw images are input directly to a CNN for inference, white-balance correction could be implicitly performed by the first convolutional layer which not only learns to remap the pixel colors to channels, but can also learn a task relevant weighting for information extraction.

RGB data is used for many image compression algorithms. As described herein, an independent generation of training data based on mosaic patterns may not be needed. Instead, the input layer of the neural network is configured to convert input RGB data in a pre-training dataset to the color filter array format, which is then used to train the neural network to work directly on input raw images in the color filter array format.

### Stride Alignment

FIG. 1 is a diagram illustrating an example mosaic pattern 100 for image sensor data, in accordance with example embodiments. In the case of image processing, the input is typically either singular or a set of three channel images consisting of red, green, and blue color channels. Such color images are commonly captured with an array of light sensors covered with different color filters, called a color filter array, which are generally arranged as a repeated mosaic. Examples of color filters can be, for example, a Bayer filter, a modified Bayer filter such as RGBE where a green filter is modified to an “emerald” filter, a red-yellow-yellow-blue (RYYB) filter, a cyan-yellow-yellow-magenta (CYYM) filter, a cyan-yellow-green-magenta (CYGM) filter, various modifications of the Bayer filter (e.g., RGBW where a green filter is modified to a “white” filter, a Quad Bayer filter (comprising 4× blue, 4× red, and 8× green filters), RYYB Quad Bayer (comprising 4× blue, 4× red, and 8× yellow filters), nonacell (comprising 9× blue, 9× red, and 18× green filters), RCCC filter (a monochrome sensor with a red channel to detect traffic lights, stop signs, etc.), RCCB filter (where the green pixels are clear), and others. For example, the color filter can also correspond to filters used in multispectral sensors. For low latency and memory bound applications it is sometimes desirable to process the raw color mosaic image as opposed to some RGB equivalent that was reconstructed from the raw image.

A naive application of convolutional operations to a raw color mosaic or color filter array may be sub-optimal if the stride of the input receptive field of the input layer of the neural network is not a multiple of the input mosaic stride, also referred to as the input grid stride for the color filter array for the input raw image data. The term “stride” as used herein, generally refers to a number of pixel shifts by the input receptive field over the color filter array. For example using the default stride or input grid stride of 1 on a common Bayer pattern would result in the same kernel weight being responsible for all colors in the mosaic, as opposed to a single color as performed in the multi-channel RGB images. Such use of the standard convolution on mosaics or color filter arrays where the color changes by location can significantly diminish the spatial equivariant property of convolutions at a local scale. Such use of the standard convolution can also degrade learning by the neural network as a weight is shared across multiple colors, thereby potentially losing discriminative information offered from using a color sensor. This can result in a ubiquitous application of CNNs on multi-channel color images.

The techniques described herein leverage the structure of the repeated pattern that could be viewed as a strided filter. By ensuring that the stride of the first convolutional layer is a multiple of the stride for the input image, the same kernel weight is always applied for the same color.

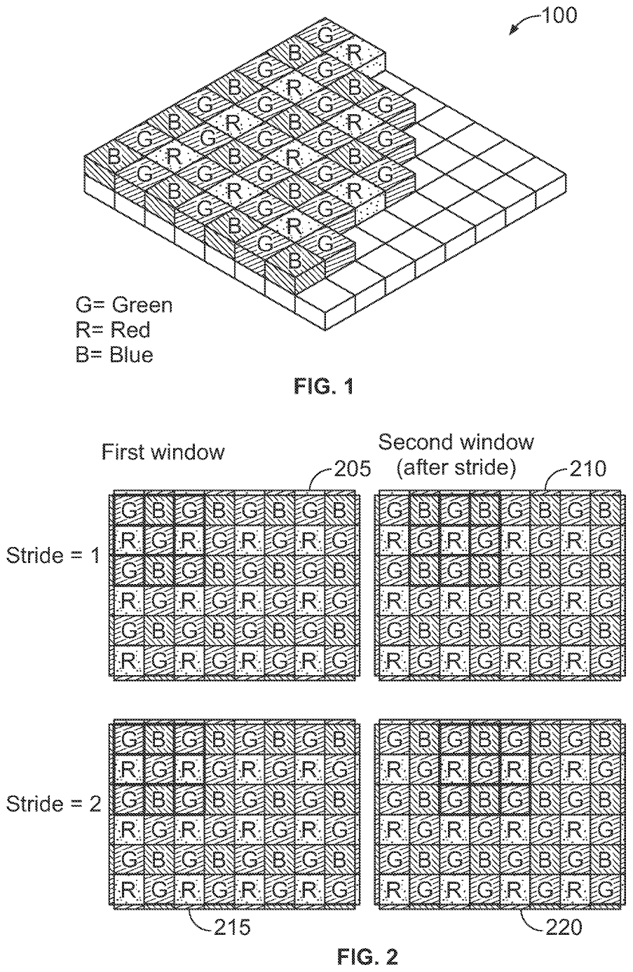

FIG. 2 is a diagram illustrating example strides aligned to a mosaic pattern for image sensor data, in accordance with example embodiments. First pattern 205 shows a first window with a single stride for a 3×3 Bayer pattern. As illustrated in second pattern 210, after a single stride is applied, the 3×3 kernel weights are being shared across multiple colors. For example, the weights applied to the entries of the first 3×3 grid (“GBG; RGR; GBG”) in the first pattern 205 are also the weights that are applied to the next 3×3 grid (“BGB; GRG; BGB”) in the second pattern 210 when a single stride is applied. Therefore, the same weights are applied to different colors, thereby making the processing agnostic to color-based differences in the raw image data.

However, third pattern 215 shows a first window with a stride of 2 for a 3×3 Bayer pattern. As illustrated in fourth pattern 220, after a stride of 2 is applied, the 3×3 kernel weights are not being shared across multiple colors. For example, the weights applied to the entries of the first 3×3 grid (“GBG; RGR; GBG”) in the third pattern 215 are also the weights that are applied to the next 3×3 grid (“GBG; RGR; GBG”) in the fourth pattern 220 after a stride of 2 is applied. Therefore, the same weights are applied to the same colors, thereby extracting color-based differences in the raw image data.

When applied with multiple output channels for this convolution, the resulting operation may be viewed as a mapping of the spatial color encoding to a channel-wise color encoding. While a stride greater than one results in down-sampling the spatial resolution, this is commonly a desirable property with many CNNs working on RGB images employing strided convolutions early in their stack to benefit from an immediate saving compute time. Furthermore, many cameras configured to provide raw (Bayer) images often lack white-balance correction (e.g., a fixed weighting applied to each color to simulate equal values for white light). In applications where raw images are input directly to a CNN for inference, white-balance correction could be implicitly performed by the first convolutional layer which not only learns to remap the pixel colors to channels, but can also learn a task relevant weighting for information extraction.

In processing of raw mosaic images as inputs to a CNN, common techniques for data augmentation, such as random cropping and color alteration, need to be adapted for the single-channel strided mosaic pattern. As described previously, color may be encoded by its position in the mosaic; accordingly, a cropping operation can be performed at a multiple of the mosaic pattern stride. Another aspect relates to color augmentation. Color augmentation may be performed in the described framework via multiple options: (a) by converting a raw mosaic to RGB, by performing standard color augmentation, and then converting back from RGB to a raw mosaic; (b) by generating noise for each unique color in the mosaic, rearranging these values repeated to match the input mosaic, adding this to the raw input image, and changing the individual color values between batches; and (c) by applying color augmentation after the first convolutional layer as the strided and aligned convolution maps the position encoded colors to channel encodings.

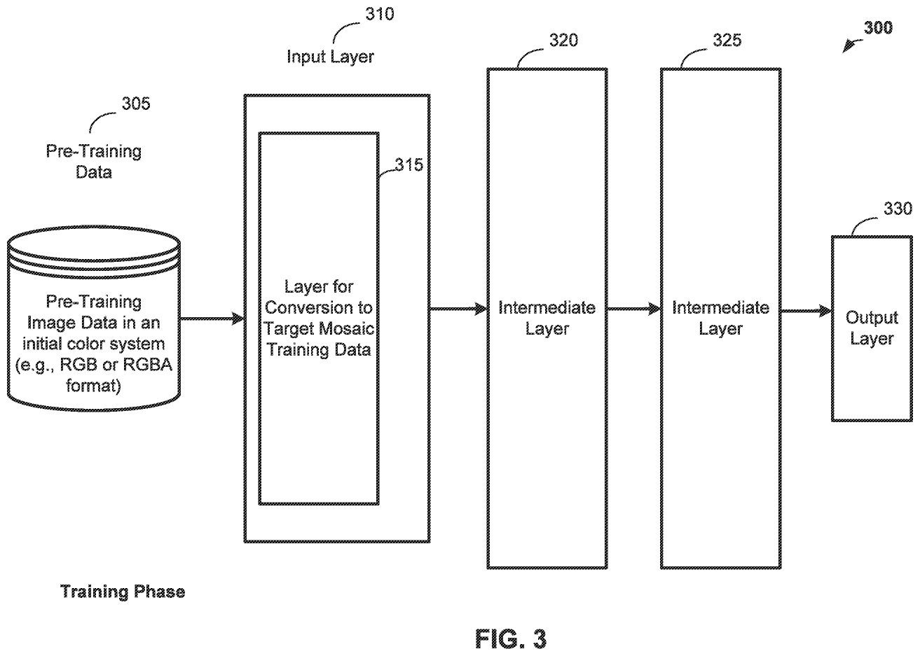

FIG. 3 is a diagram illustrating an example training phase 300 for a neural network, in accordance with example embodiments. The method includes receiving, by an input layer 310 of the neural network, a pre-training dataset 305 comprising image data (e.g., in red-green-blue (RGB) format, RGBA format, etc.). The method also includes converting, by the input layer 310 of the neural network, the pre-training dataset 305 comprising image data to a training dataset comprising image data in a color filter array, wherein the color filter array corresponds to an arrangement of RGB color filters on a grid of photosensors corresponding to a camera sensor. As illustrated, the input layer 310 can include an additional layer 315 that performs the converting of the pre-training dataset 305. The method additionally includes training the neural network based on the generated training dataset by aligning a stride of an input receptive field of the input layer of the neural network to match an input grid stride for the color filter array, wherein the stride of the input receptive field corresponds to a number of pixel shifts over the color filter array, and performing, based on the aligned stride, the image processing on one or more images of the generated training dataset Generally such processes are performed by one or more intermediate layers 320, 325, and an output is generated by an output layer 330. Although two intermediate (or hidden) layers are shown, this is for illustrative purposes only. Generally, the neural network may comprise several intermediate layers. The method further includes providing the trained neural network.

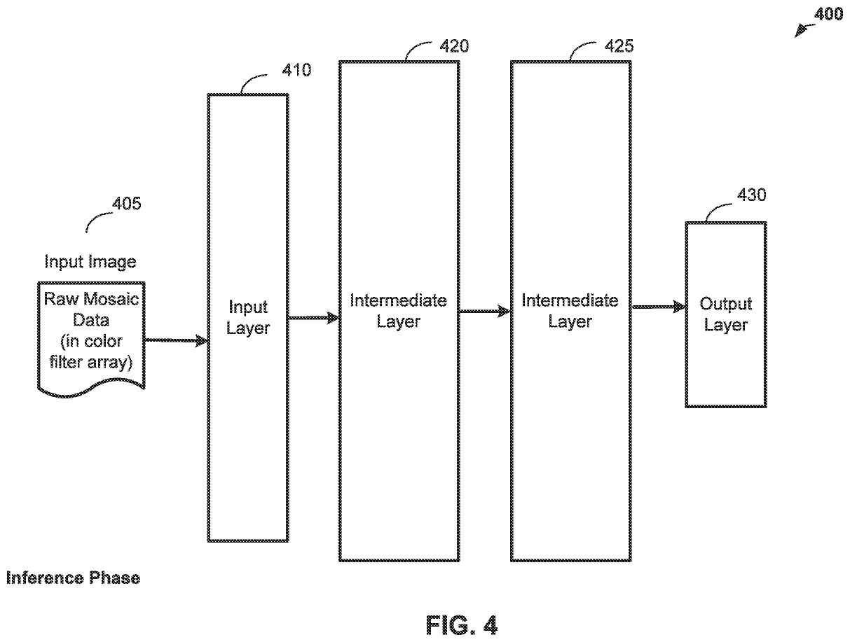

FIG. 4 is a diagram illustrating an example inference phase 400 for a neural network, in accordance with example embodiments. The method includes receiving, by a computing device, input raw image data 405 arranged in the color filter array, wherein the color filter array corresponds to an arrangement of color filters on a grid of photosensors corresponding to a camera sensor. The method also includes applying, by the computing device, the trained neural network for image processing, the neural network having been trained by align a stride of an input receptive field of the input layer of the neural network to match an input grid stride for the color filter array for the input raw image data. For example, input layer 410 may perform the aligning of the stride of the input receptive field. The stride of the input receptive field corresponds to a number of pixel shifts over the color filter array. During training, as illustrated in FIG. 3, the input layer 310 can include an additional layer 315 that performs the converting of the pre-training dataset 305. However, the additional layer 315 is removed during the inference phase, and the neural network operates directly on the color filter array for the input raw image data. Image processing on the input raw image data 405 can be performed based on the aligned stride. The method also includes performing the image processing on the input raw image data based on the aligned stride of the input receptive field. The method also includes performing the image processing on the input raw image data based on the aligned stride of the input receptive field. The method also includes performing the image processing on the input raw image data based on the aligned stride of the input receptive field. The method also includes performing the image processing on the input raw image data based on the aligned stride of the input receptive field. The method additionally includes providing, by the computing device, the output of the image processing on the input raw image data of the image processing on the input raw image data of the image processing on the input raw image data of the image processing on the input raw image data of the image processing on the input raw image data 405. Generally such processes are performed by one or more intermediate layers 420, 425, and an output is generated by an output layer 430.

### Example Applications

In one aspect, the input data for object detection comprises image data. Efficiency and accuracy of object detection based on alignment based striding is generally higher than that of other models.

The model can reside on a mobile device and perform object detection.

The model can analyze video data rather than image data for the purposes of open tracking (track object when entering/leaving the frame and/or specific locations within the frame), anomaly detection (for security/surveillance tracking), and/or segmentation.

The techniques can be applied to robotic vision, autonomous and semi-autonomous driving, intelligent cameras, security and/or surveillance cameras, satellite image processing, space exploration, and so forth.

In autonomous and semi-autonomous driving, the techniques can be applied to object detection during point cloud processing of videos and still images.

The techniques can be applied in smart edge devices that have a low memory footprint.

The techniques can be applied in privacy sensitive applications where processing is pushed as close to the sensor so that only high-level semantic features are transmitted as opposed to full imagery.

The applications can include webcam effects in live streaming or video calls.

The described techniques can be used in object detection and tracking. More particularly, for high-speed tracking.

### Example Application for Object Detection and Tracking: Robotic Table Tennis

One example of high-speed object detection and tracking is in robotic table tennis. For example, a robotic table tennis system may use a ball (e.g., an orange ball), and the described techniques can significantly improve detection, and tracking of the orange ball, thereby enhancing the speed of detection and/or tracking of the ball. A tennis ball is generally small and moves fast, so capturing it accurately can be a challenge. Ideally the cameras would be as close to the action as possible, but in a dual camera setup, it is preferable for each camera to view the entire play area. Additionally, putting sensitively calibrated cameras in the path of fast moving balls is not ideal.

Improved ball detection can significantly impact the speed and reliability of the perception system. The perception system uses a temporal convolutional architecture to process each camera's video stream independently and provides information about the ball location and velocity for the downstream triangulation and filtering. The system uses raw Bayer images and temporal convolutions, which allow the system to efficiently process each video stream independently, thereby improving the latency and accuracy of ball detection. In some embodiments, the output structure may generate per location predictions that include: a ball score indicating the likelihood of the ball center at that location, a two-dimensional (2D) local offset to accommodate sub-pixel resolution, and a 2D estimate of the ball velocity in pixels.

A ball detection network may take the raw Bayer pattern image as input directly from the high speed camera after cropping to the play area at an example resolution of 512×1024. By skipping Bayer to RGB conversion, 1 ms (or 15% of the time between images) of conversion induced latency per camera may be avoided, and data transferred from camera to host to accelerator may be reduced by two-thirds (⅔), further reducing latency. In contrast to other models utilizing Bayer images, loss in performance using the raw format can be minimized, largely due to the customized attention given to structure of the 2×2 Bayer pattern and ensuring that the first convolution layer is set to have a stride of 2×2. Such an alignment indicates that the individual weights of the first layer are responsible for a single color across all positions of the convolution operation. The immediate striding also benefits wall-clock time by down-sampling the input to a quarter of the original size. The alignment with the Bayer pattern can also be extended to crop operations during training of the ball detection network.

The spatial convolution layers capture shape and color information while downsampling the image size to reduce computation. In some embodiments, the image processing may involve operating on single channel raw images means. Accordingly, the first layer may be configured to have a 2×2 stride matching the Bayer pattern. Such a configuration enables the weights of the convolutional kernel to be applied to the same colored pixels at all spatial locations. In some embodiments, five convolutional layers may be applied with the first three including batch normalization before a ReLU activation. Two of these five layers may employ a buffered temporal mechanism resulting in a highly compact network with few parameters (e.g., 27K parameters). Also, in contrast to typical temporal convolutions operating on video data, there is a lack of a time dimension. Instead the temporal convolutional layers may concatenate previous inputs to the current features along the channel dimensions. Accordingly, the next convolutional layer with weights may span two timesteps.

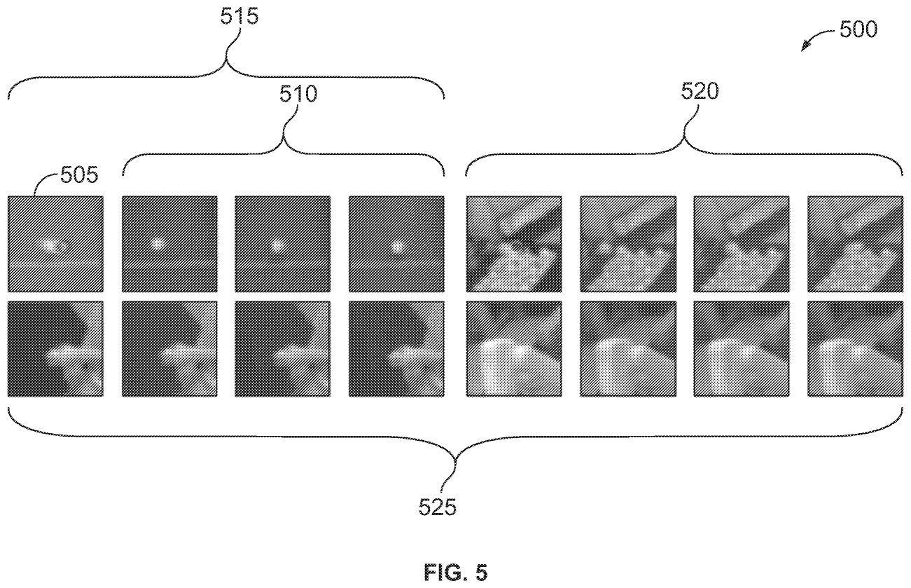

FIG. 5 illustrates examples of training patches 500 for ball detector comparisons between various object detection models for a robotic table tennis system, in accordance with example embodiments. Examples illustrate training patches for a ball detector which consist of the three previous frames. The first RGB formatted patch 505 is for visualization purposes to highlight the motion of the ball in play with the current and next labeled position indicated with white and black circles respectively. The three single channel images 510 to the right of the first RGB image 505 illustrate the raw Bayer pattern as expected by the detector. Top row illustrates two sequences of three frames 515 and 520 centered on the final ball position (modulo 2 to match Bayer stride). Bottom row 525 shows hard negative examples where the center position includes a bright spot with some motion originating from a person carrying a ball-in-hand or from the robot itself.

These and other example applications are contemplated within a scope of this disclosure.

### Training Machine Learning Models for Generating Inferences/predictions

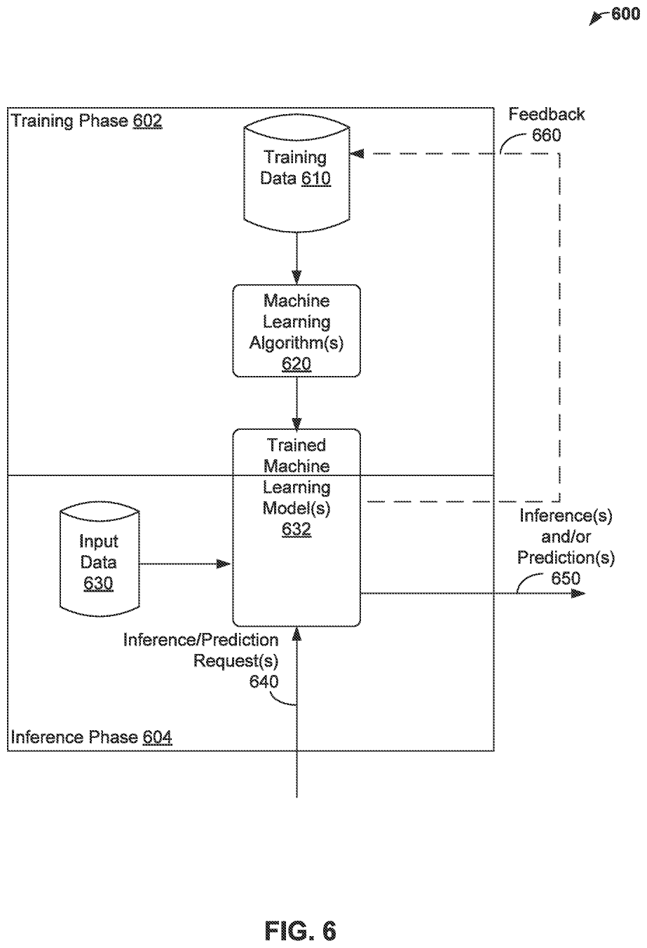

FIG. 6 shows diagram 600 illustrating a training phase 602 and an inference phase 604 of trained machine learning model(s) 632, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 6 shows training phase 602 where one or more machine learning algorithms 620 are being trained on training data 610 to become trained machine learning model(s) 632. Then, during inference phase 604, trained machine learning model(s) 632 can receive input data 630 and one or more inference/prediction requests 640 (perhaps as part of input data 630) and responsively provide as an output one or more inferences and/or prediction(s) 650.

As such, trained machine learning model(s) 632 can include one or more models of one or more machine learning algorithms 620. Machine learning algorithm(s) 620 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 620 may be supervised or unsupervised, and may implement any suitable combination of online and offline learning.

In some examples, machine learning algorithm(s) 620 and/or trained machine learning model(s) 632 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 620 and/or trained machine learning model(s) 632. In some examples, trained machine learning model(s) 632 can be trained, reside and execute to provide inferences on a particular computing device, and/or otherwise can make inferences for the particular computing device.

During training phase 602, machine learning algorithm(s) 620 can be trained by providing at least training data 610 as training input using unsupervised, supervised, semi-supervised, and/or reinforcement learning techniques. Unsupervised learning involves providing a portion (or all) of training data 610 to machine learning algorithm(s) 620 and machine learning algorithm(s) 620 determining one or more output inferences based on the provided portion (or all) of training data 610. Supervised learning involves providing a portion of training data 610 to machine learning algorithm(s) 620, with machine learning algorithm(s) 620 determining one or more output inferences based on the provided portion of training data 610, and the output inference(s) are either accepted or corrected based on correct results associated with training data 610. In some examples, supervised learning of machine learning algorithm(s) 620 can be governed by a set of rules and/or a set of labels for the training input, and the set of rules and/or set of labels may be used to correct inferences of machine learning algorithm(s) 620.

Semi-supervised learning involves having correct results for part, but not all, of training data 610. During semi-supervised learning, supervised learning is used for a portion of training data 610 having correct results, and unsupervised learning is used for a portion of training data 610 not having correct results. Reinforcement learning involves machine learning algorithm(s) 620 receiving a reward signal regarding a prior inference, where the reward signal can be a numerical value. During reinforcement learning, machine learning algorithm(s) 620 can output an inference and receive a reward signal in response, where machine learning algorithm(s) 620 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 620 and/or trained machine learning model(s) 632 can be trained using other machine learning techniques, including but not limited to, incremental learning and curriculum learning.

In some examples, machine learning algorithm(s) 620 and/or trained machine learning model(s) 632 can use transfer learning techniques. For example, transfer learning techniques can involve trained machine learning model(s) 632 being pre-trained on one set of data and additionally trained using training data 610. More particularly, machine learning algorithm(s) 620 can be pre-trained on data from one or more computing devices and a resulting trained machine learning model provided to computing device CD1, where CD1 is intended to execute the trained machine learning model during inference phase 604. Then, during training phase 602, the pre-trained machine learning model can be additionally trained using training data 610, where training data 610 can be derived from kernel and non-kernel data of computing device CD1. This further training of the machine learning algorithm(s) 620 and/or the pre-trained machine learning model using training data 610 of CD1's data can be performed using either supervised or unsupervised learning. Once machine learning algorithm(s) 620 and/or the pre-trained machine learning model has been trained on at least training data 610, training phase 602 can be completed. The trained resulting machine learning model can be utilized as at least one of trained machine learning model(s) 632.

In particular, once training phase 602 has been completed, trained machine learning model(s) 632 can be provided to a computing device, if not already on the computing device. Inference phase 604 can begin after trained machine learning model(s) 632 are provided to computing device CD1.

During inference phase 604, trained machine learning model(s) 632 can receive input data 630 and generate and output one or more corresponding inferences and/or prediction(s) 650 about input data 630. As such, input data 630 can be used as an input to trained machine learning model(s) 632 for providing corresponding inference(s) and/or prediction(s) 650 to kernel components and non-kernel components. For example, trained machine learning model(s) 632 can generate inference(s) and/or prediction(s) 650 in response to one or more inference/prediction requests 640. In some examples, trained machine learning model(s) 632 can be executed by a portion of other software. For example, trained machine learning model(s) 632 can be executed by an inference or prediction daemon to be readily available to provide inferences and/or predictions upon request. Input data 630 can include data from computing device CD1 executing trained machine learning model(s) 632 and/or input data from one or more computing devices other than CD1. For example, input data 630 can include a collection of images in RGB format. Other types of input data are possible as well.

Inference(s) and/or prediction(s) 650 can include output images, output intermediate images, numerical values, and/or other output data produced by trained machine learning model(s) 632 operating on input data 630 (and training data 610). In some examples, trained machine learning model(s) 632 can use output inference(s) and/or prediction(s) 650 as input feedback 1160. Trained machine learning model(s) 632 can also rely on past inferences as inputs for generating new inferences.

A neural network comprising an input receptive field of an input layer and a conversion layer to convert RGB images to images in color filter array corresponding to a mosaic pattern can be an example of machine learning algorithm(s) 620. After training, the trained version of the neural network can be an example of trained machine learning model(s) 632, such as, for example, a neural network comprising an input receptive field of an input layer without the conversion layer. In this approach, an example of the one or more inference/prediction request(s) 640 can be a request to predict an object in an input image and a corresponding example of inferences and/or prediction(s) 650 can be a predicted object in the input image.

In some examples, one computing device CD_SOLO can include the trained version of the neural network, perhaps after training. Then, computing device CD_SOLO can receive a request to align a stride of an input receptive field of the input layer of the neural network to match an input grid stride for the color filter array for the input raw image data, and use the trained version of the neural network to perform such operations.

In some examples, two or more computing devices CD_CLI and CD_SRV can be used to provide output images; e.g., a first computing device CD_CLI can generate and send requests to align a stride of an input receptive field of the input layer of the neural network to match an input grid stride for the color filter array for the input raw image data to a second computing device CD_SRV. Then, CD_SRV can use the trained version of the neural network, to perform such operations, and respond to the requests from CD_CLI. Then, upon reception of responses to the requests, CD_CLI can provide the requested input layer of the neural network to match an input grid stride (e.g., using a user interface and/or a display, a printed copy, an electronic communication, etc.).

### Example Data Network

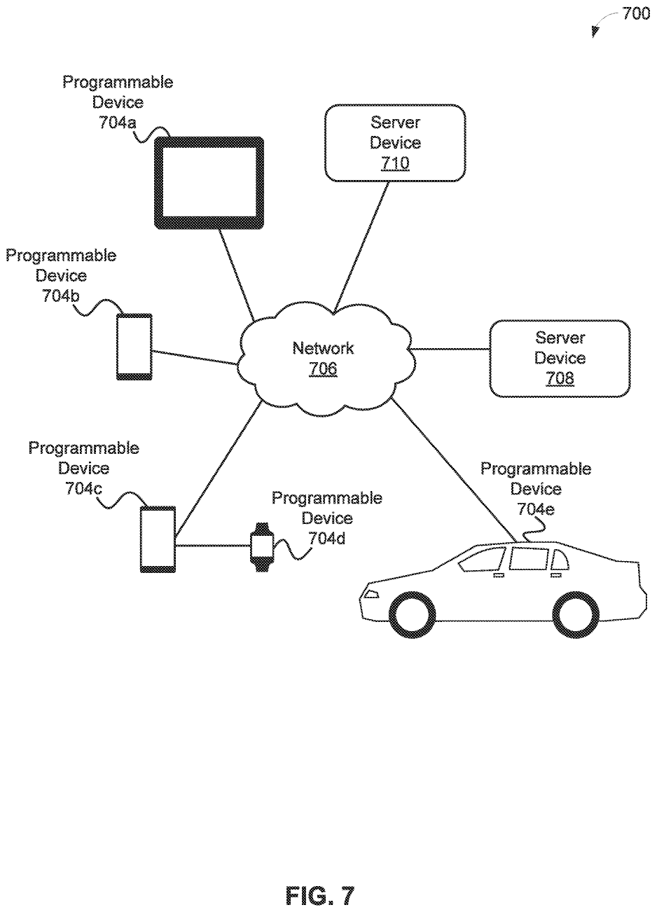

FIG. 7 depicts a distributed computing architecture 700, in accordance with example embodiments. Distributed computing architecture 700 includes server devices 708, 710 that are configured to communicate, via network 706, with programmable devices 704a, 704b, 704c, 704d, 704e. Network 706 may correspond to a local area network (LAN), a wide area network (WAN), a WLAN, a WWAN, a corporate intranet, the public Internet, or any other type of network configured to provide a communications path between networked computing devices. Network 706 may also correspond to a combination of one or more LANs, WANs, corporate intranets, and/or the public Internet.

Although FIG. 7 only shows five programmable devices, distributed application architectures may serve tens, hundreds, or thousands of programmable devices. Moreover, programmable devices 704a, 704b, 704c, 704d, 704e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 704a, 704b, 704c, 704e, programmable devices can be directly connected to network 706. In other examples, such as illustrated by programmable device 704d, programmable devices can be indirectly connected to network 706 via an associated computing device, such as programmable device 704c. In this example, programmable device 704c can act as an associated computing device to pass electronic communications between programmable device 704d and network 706. In other examples, such as illustrated by programmable device 704e, a computing device can be part of and/or inside a vehicle, such as a car, a truck, a bus, a boat or ship, an airplane, etc. In other examples not shown in FIG. 7, a programmable device can be both directly and indirectly connected to network 706.

Server devices 708, 710 can be configured to perform one or more services, as requested by programmable devices 704a-704e. For example, server device 708 and/or 710 can provide content to programmable devices 704a-704e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 708 and/or 710 can provide programmable devices 704a-704ewith access to software for database, search, computation, graphical, audio, video, World Wide Web/Internet utilization, and/or other functions. Many other examples of server devices are possible as well.

### Computing Device Architecture

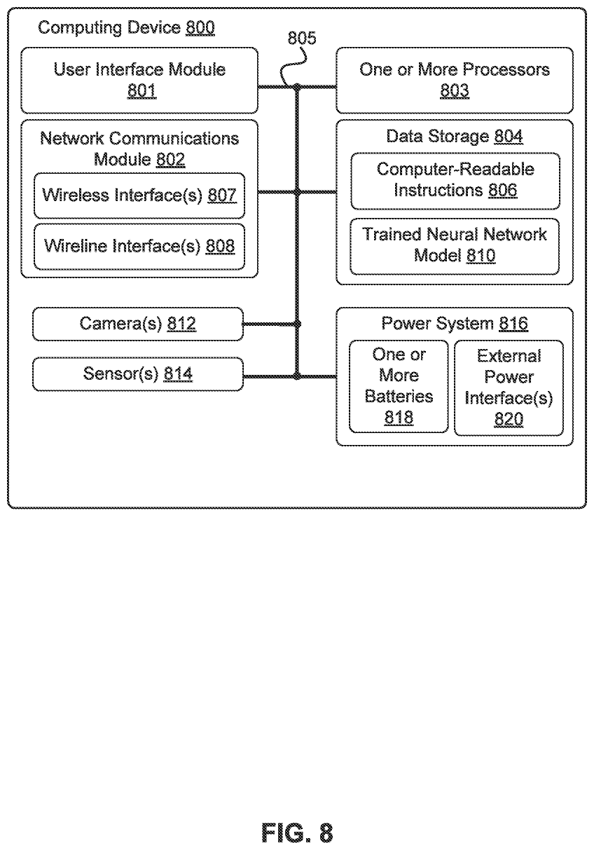

FIG. 8 is a block diagram of an example computing device 800, in accordance with example embodiments. In particular, computing device 800 shown in FIG. 8 can be configured to perform at least one function of and/or related to the neural networks, and/or methods 1000, 1100.

Computing device 800 may include a user interface module 801, a network communications module 802, one or more processors 803, data storage 804, one or more camera(s) 812, one or more sensors 814, and power system 816, all of which may be linked together via a system bus, network, or other connection mechanism 805.

User interface module 801 can be operable to send data to and/or receive data from external user input/output devices. For example, user interface module 801 can be configured to send and/or receive data to and/or from user input devices such as a touch screen, a computer mouse, a keyboard, a keypad, a touch pad, a trackball, a joystick, a voice recognition module, and/or other similar devices. User interface module 801 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 801 can also be configured to generate audible outputs, with devices such as a speaker, speaker jack, audio output port, audio output device, earphones, and/or other similar devices. User interface module 801 can further be configured with one or more haptic devices that can generate haptic outputs, such as vibrations and/or other outputs detectable by touch and/or physical contact with computing device 800. In some examples, user interface module 801 can be used to provide a graphical user interface (GUI) for utilizing computing device 800, such as, for example, a graphical user interface of a mobile phone device.

Network communications module 802 can include one or more devices that provide one or more wireless interface(s) 807 and/or one or more wireline interface(s) 808 that are configurable to communicate via a network. Wireless interface(s) 807 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 808 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 802 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 803 can include one or more general purpose processors, and/or one or more special purpose processors (e.g., digital signal processors, tensor processing units (TPUs), graphics processing units (GPUs), application specific integrated circuits, etc.). One or more processors 803 can be configured to execute computer-readable instructions 706 that are contained in data storage 804 and/or other instructions as described herein.

Data storage 804 can include one or more non-transitory computer-readable storage media that can be read and/or accessed by at least one of one or more processors 803. The one or more computer-readable storage media can include volatile and/or non-volatile storage components, such as optical, magnetic, organic or other memory or disc storage, which can be integrated in whole or in part with at least one of one or more processors 803. In some examples, data storage 804 can be implemented using a single physical device (e.g., one optical, magnetic, organic or other memory or disc storage unit), while in other examples, data storage 804 can be implemented using two or more physical devices.

Data storage 804 can include computer-readable instructions 706 and perhaps additional data. In some examples, data storage 804 can include storage required to perform at least part of the herein-described methods, scenarios, and techniques and/or at least part of the functionality of the herein-described devices and networks. In some examples, data storage 804 can include storage for a trained neural network model 810 (e.g., a model of trained neural networks such as a vision and language model). In particular of these examples, computer-readable instructions 806 can include instructions that, when executed by one or more processors 803, enable computing device 800 to provide for some or all of the functionality of trained neural network model 810.

In some examples, computing device 800 can include one or more camera(s) 812. Camera(s) 812 can include one or more image capture devices, such as still and/or video cameras, equipped to capture light and record the captured light in one or more images; that is, camera(s) 812 can generate image(s) of captured light. The one or more images can be one or more still images and/or one or more images utilized in video imagery. Camera(s) 812 can capture light and/or electromagnetic radiation emitted as visible light, infrared radiation, ultraviolet light, and/or as one or more other frequencies of light.

In some examples, computing device 800 can include one or more sensors 814. Sensors 814 can be configured to measure conditions within computing device 800 and/or conditions in an environment of computing device 800 and provide data about these conditions. For example, sensors 814 can include one or more of: (i) sensors for obtaining data about computing device 800, such as, but not limited to, a thermometer for measuring a temperature of computing device 800, a battery sensor for measuring power of one or more batteries of power system 816, and/or other sensors measuring conditions of computing device 800; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 800, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 800, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 800, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 814 are possible as well.

Power system 816 can include one or more batteries 818 and/or one or more external power interfaces 820 for providing electrical power to computing device 800. Each battery of the one or more batteries 818 can, when electrically coupled to the computing device 800, act as a source of stored electrical power for computing device 800. One or more batteries 818 of power system 816 can be configured to be portable. Some or all of one or more batteries 818 can be readily removable from computing device 800. In other examples, some or all of one or more batteries 818 can be internal to computing device 800, and so may not be readily removable from computing device 800. Some or all of one or more batteries 818 can be rechargeable. For example, a rechargeable battery can be recharged via a wired connection between the battery and another power supply, such as by one or more power supplies that are external to computing device 800 and connected to computing device 800 via the one or more external power interfaces. In other examples, some or all of one or more batteries 818 can be non-rechargeable batteries.

One or more external power interfaces 820 of power system 816 can include one or more wired-power interfaces, such as a USB cable and/or a power cord, that enable wired electrical power connections to one or more power supplies that are external to computing device 800. One or more external power interfaces 820 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 820, computing device 800 can draw electrical power from the external power source the established electrical power connection. In some examples, power system 816 can include related sensors, such as battery sensors associated with the one or more batteries or other types of electrical power sensors.

### Cloud-Based Servers

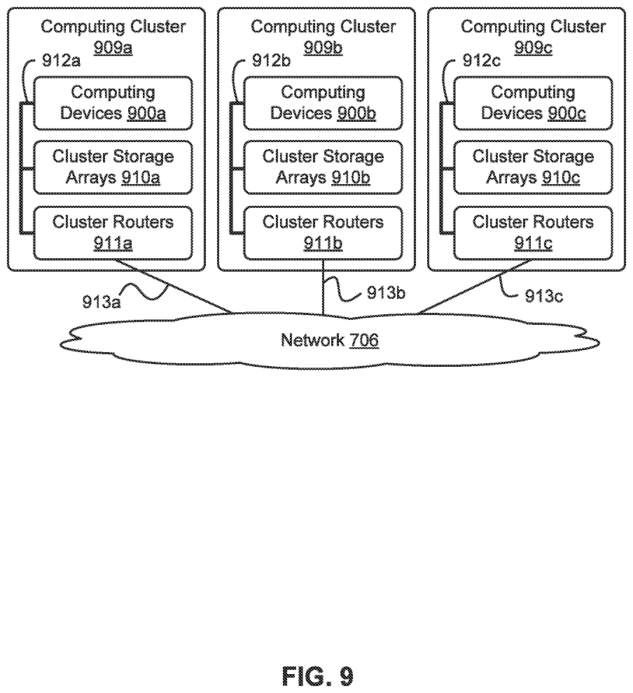

FIG. 9 depicts a cloud-based server system in accordance with an example embodiment. In FIG. 9, functionality of a neural network, and/or a computing device can be distributed among computing clusters 909a, 909b, 909c. Computing cluster 909a can include one or more computing devices 900a, cluster storage arrays 910a, and cluster routers 911a connected by a local cluster network 912a. Similarly, computing cluster 909b can include one or more computing devices 900b, cluster storage arrays 910b, and cluster routers 911b connected by a local cluster network 912b. Likewise, computing cluster 909c can include one or more computing devices 900c, cluster storage arrays 910c, and cluster routers 911c connected by a local cluster network 912c.

In some embodiments, computing clusters 909a, 909b, 909c can be a single computing device residing in a single computing center. In other embodiments, computing clusters 909a, 909b, 909c can include multiple computing devices in a single computing center, or even multiple computing devices located in multiple computing centers located in diverse geographic locations. For example, FIG. 9 depicts each of computing clusters 909a, 909b, 909c residing in different physical locations.

In some embodiments, data and services at computing clusters 909a, 909b, 909c can be encoded as computer readable information stored in non-transitory, tangible computer readable media (or computer readable storage media) and accessible by other computing devices. In some embodiments, computing clusters 909a, 909b, 909c can be stored on a single disk drive or other tangible storage media, or can be implemented on multiple disk drives or other tangible storage media located at one or more diverse geographic locations.

In some embodiments, each of computing clusters 909a, 909b, and 909c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 909a, for example, computing devices 900a can be configured to perform various computing tasks of a neural network, and/or a computing device. In one embodiment, the various functionalities of a neural network, and/or a computing device can be distributed among one or more of computing devices 900a, 900b, 900c. Computing devices 900b and 900c in respective computing clusters 909b and 909c can be configured similarly to computing devices 900a in computing cluster 909a. On the other hand, in some embodiments, computing devices 900a, 900b, and 900c can be configured to perform different functions.

In some embodiments, computing tasks and stored data associated with a neural network, and/or a computing device can be distributed across computing devices 900a, 900b, and 900c based at least in part on the processing requirements of a neural network, and/or a computing device, the processing capabilities of computing devices 900a, 900b, 900c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 910a, 910b, 910c of computing clusters 909a, 909b, 909c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a conditioned, axial self-attention based neural network, and/or a computing device can be distributed across computing devices 900a, 900b, 900c of computing clusters 909a, 909b, 909c, various active portions and/or backup portions of these components can be distributed across cluster storage arrays 910a, 910b, 910c. For example, some cluster storage arrays can be configured to store one portion of the data of a first layer of a neural network, and/or a computing device, while other cluster storage arrays can store other portion(s) of data of second layer of a neural network, and/or a computing device. Also, for example, some cluster storage arrays can be configured to store the data of an encoder of a neural network, while other cluster storage arrays can store the data of a decoder of a neural network. Additionally, some cluster storage arrays can be configured to store backup versions of data stored in other cluster storage arrays.

Cluster routers 911a, 911b, 911c in computing clusters 909a, 909b, 909c can include networking equipment configured to provide internal and external communications for the computing clusters. For example, cluster routers 911a in computing cluster 909a can include one or more internet switching and routing devices configured to provide (i) local area network communications between computing devices 900a and cluster storage arrays 910a via local cluster network 912a, and (ii) wide area network communications between computing cluster 909a and computing clusters 909b and 909c via wide area network link 913a to network 706. Cluster routers 911b and 911c can include network equipment similar to cluster routers 911a, and cluster routers 911b and 911c can perform similar networking functions for computing clusters 909b and 909b that cluster routers 911a perform for computing cluster 909a.

In some embodiments, the configuration of cluster routers 911a, 911b, 911c can be based at least in part on the data communication requirements of the computing devices and cluster storage arrays, the data communications capabilities of the network equipment in cluster routers 911a, 911b, 911c, the latency and throughput of local cluster networks 912a, 912b, 912c, the latency, throughput, and cost of wide area network links 913a, 913b, 913c, and/or other factors that can contribute to the cost, speed, fault-tolerance, resiliency, efficiency and/or other design criteria of the moderation system architecture.

### Example Methods of Operation

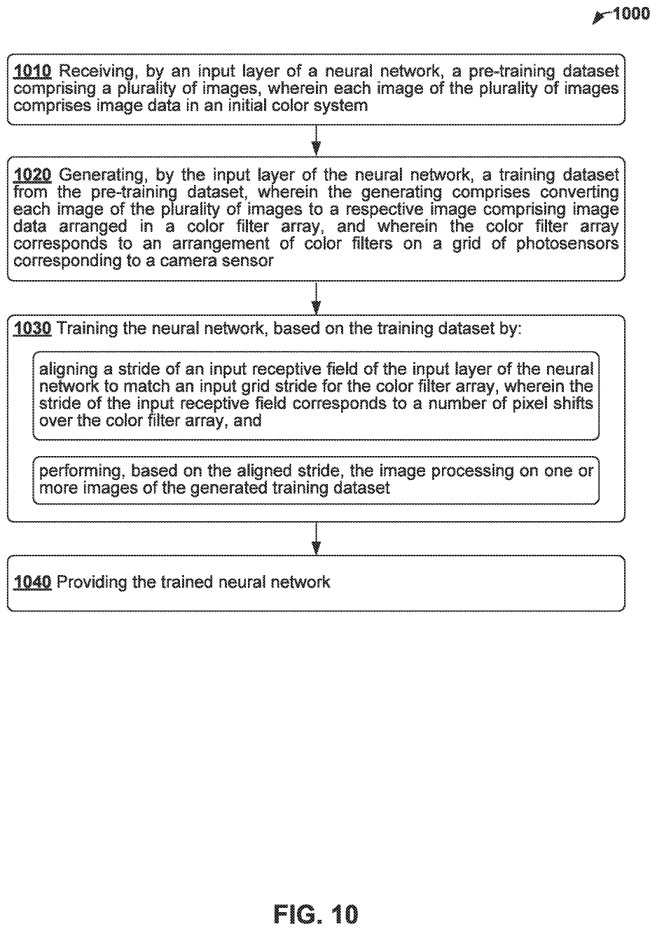

FIG. 10 is a flowchart of a method 1000 of training a neural network for image processing, in accordance with example embodiments. Method 1000 can be executed by a computing device, such as computing device 800. Method 1000 can begin at block 1010, where the method involves receiving, by an input layer of the neural network, a pre-training dataset comprising a plurality of images, wherein each image of the plurality of images comprises image data in an initial color system. For example, the initial color system may include a red-green-blue (RGB) format, RGBA format, cyan-magenta-yellow (CMY), cyan-magenta-yellow-key (CMYK), and so forth. In some embodiments, the initial color system may be the color filter array.

At block 1020, the method involves generating, by the input layer of the neural network, a training dataset from the pre-training dataset, wherein the generating comprises converting each image of the plurality of images to a respective image comprising image data arranged in a color filter array, and wherein the color filter array corresponds to an arrangement of color filters on a grid of photosensors corresponding to a camera sensor.

At block 1030, the method involves training the neural network based on the generated training dataset by aligning a stride of an input receptive field of the input layer of the neural network to match an input grid stride for the color filter array, wherein the stride of the input receptive field corresponds to a number of pixel shifts over the color filter array, and performing, based on the aligned stride, the image processing on one or more images of the generated training dataset

At block 1040, the method involves providing the trained neural network.

In some embodiments, the aligning of the stride involves initializing the input receptive field of the input layer of the neural network at a first position of the input grid stride of the color filter array.

In some embodiments, the color filter array may include a 2×2 Bayer arrangement of color filters, and the stride of the input receptive field may be two (2).

In some embodiments, the color filter array may include a 4×4 Quad Bayer arrangement of color filters, and the stride of the input receptive field may be four (4).

In some embodiments, the stride of the input receptive field may be a multiple of the input grid stride of the color filter array.

Some embodiments involve detecting a region of interest in an input image of the generated training dataset. The performing of the image processing may be based on the detected region of interest.

Some embodiments involve cropping a portion of the input image, wherein the cropped portion comprises the detected region of interest, and wherein the cropping of the portion is aligned to match the grid stride for the color filter array. The aligning of the stride involves aligning the stride of the input receptive field of the input layer of the neural network to match a grid stride for the color filter array for the cropped portion.

In some embodiments, the grid of photosensors corresponding to the camera sensor may be part of a digital image capturing device. The training of the neural network may be performed at the digital image capturing device.

In some embodiments, the grid of photosensors corresponding to the camera sensor may be part of a digital image capturing device. The training of the neural network may be performed at a computing device different from the digital image capturing device.

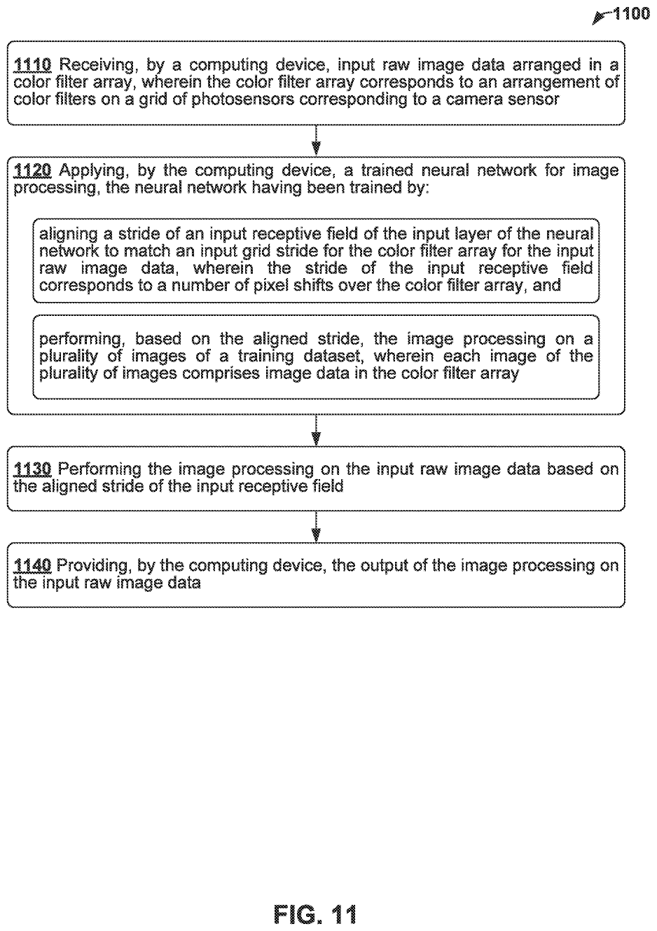

FIG. 11 is a flowchart of a method 1100 of applying a trained neural network for image processing, in accordance with example embodiments. Method 1100 can be executed by a computing device, such as computing device 800. Method 1100 can begin at block 1110, where the method involves receiving, by a computing device, input raw image data arranged in a color filter array, wherein the color filter array corresponds to an arrangement of color filters on a grid of photosensors corresponding to a camera sensor.

At block 1120, the method involves applying, by the computing device, the trained neural network for image processing, the neural network having been trained by aligning a stride of an input receptive field of the input layer of the neural network to match an input grid stride for the color filter array for the input raw image data, wherein the stride of the input receptive field corresponds to a number of pixel shifts over the color filter array, and performing, based on the aligned stride, the image processing on a plurality of images of a training dataset, wherein each image of the plurality of images comprises image data in the color filter array.

At block 1130, the method involves performing the image processing on the input raw image data based on the aligned stride of the input receptive field.

At block 1140, the method involves providing, by the computing device, the output of the image processing on the input raw image data.

In some embodiments, the neural network may have been trained by receiving, by the input layer of the neural network, a pre-training dataset comprising a plurality of images, wherein each image of the plurality of images comprises image data in an initial color system, and generating, by the input layer of the neural network, the training dataset from the pre-training dataset, wherein the generating comprises converting each image of the plurality of images to a respective image comprising image data arranged in the color filter array.

In some embodiments, the aligning of the stride may involve initializing the input receptive field of the input layer of the neural network at a first position of the input grid stride of the color filter array.

In some embodiments, the color filter array may include a 2×2 Bayer arrangement of color filters, and the stride of the input receptive field may be two (2).

In some embodiments, the color filter array may include a 4×4 Quad Bayer arrangement of color filters, and the stride of the input receptive field may be four (4).

In some embodiments, the stride of the input receptive field may be a multiple of the input grid stride of the color filter array.

Some embodiments involve detecting a region of interest in an input image of the generated training dataset. The performing of the image processing may be based on the detected region of interest.

Some embodiments involve cropping a portion of the input image, wherein the cropped portion comprises the detected region of interest, and wherein the cropping of the portion is aligned to match the grid stride for the color filter array. The aligning of the stride involves aligning the stride of the input receptive field of the input layer of the neural network to match a grid stride for the color filter array for the cropped portion.

In some embodiments, the grid of photosensors corresponding to the camera sensor may be part of a digital image capturing device. The training of the neural network may be performed at the digital image capturing device.

In some embodiments, the grid of photosensors corresponding to the camera sensor may be part of a digital image capturing device. The training of the neural network may be performed at a computing device different from the digital image capturing device.

In some embodiments, the computing device includes a digital image capturing device, and the receiving of the input raw image data involves receiving, by the computing device, the input raw image data from the digital image capturing device.

In some embodiments, the computing device includes a digital image capturing device, and the receiving of the input raw image data involves capturing, by the computing device, an image, and wherein the input raw image data is based on the captured image.

Some embodiments involve obtaining the trained neural network at the computing device. The performing of the image processing on the input raw image data by the computing device may be performed using the trained neural network.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

1. A computer-implemented method of training a neural network for image processing, comprising:
receiving, by an input layer of the neural network, a pre-training dataset comprising a plurality of images, wherein each image of the plurality of images comprises image data in an initial color system;
generating, by the input layer of the neural network, a training dataset from the pre-training dataset, wherein the generating comprises converting each image of the plurality of images to a respective image comprising image data arranged in a color filter array, and wherein the color filter array corresponds to an arrangement of color filters on a grid of photosensors corresponding to a camera sensor;
training the neural network based on the generated training dataset by:
aligning a stride of an input receptive field of the input layer of the neural network to match an input grid stride for the color filter array, wherein the stride of the input receptive field corresponds to a number of pixel shifts over the color filter array, and
performing, based on the aligned stride, the image processing on one or more images of the generated training dataset; and
providing the trained neural network.

2. The computer-implemented method of claim 1, wherein the aligning of the stride further comprises:
initializing the input receptive field of the input layer of the neural network at a first position of the input grid stride of the color filter array.

3. The computer-implemented method of claim 1, wherein the color filter array comprises a 2×2 Bayer arrangement of color filters, and wherein the stride of the input receptive field is 2.

4. The computer-implemented method of claim 1, wherein the color filter array comprises a 4×4 Quad Bayer arrangement of color filters, and wherein the stride of the input receptive field is 4.

5. The computer-implemented method of claim 1, wherein the stride of the input receptive field is a multiple of the input grid stride of the color filter array.

6. The computer-implemented method of claim 1, further comprising:
detecting a region of interest in an input image of the generated training dataset, and
wherein the performing of the image processing is based on the detected region of interest.

7. The computer-implemented method of claim 6, further comprising:
cropping a portion of the input image, wherein the cropped portion comprises the detected region of interest, and wherein the cropping of the portion is aligned to match the grid stride for the color filter array, and
wherein the aligning of the stride comprises aligning the stride of the input receptive field of the input layer of the neural network to match a grid stride for the color filter array for the cropped portion.

8. The computer-implemented method of claim 1, wherein the grid of photosensors corresponding to the camera sensor are part of a digital image capturing device, and wherein the training of the neural network is performed at the digital image capturing device.

9. The computer-implemented method of claim 1, wherein the grid of photosensors corresponding to the camera sensor are part of a digital image capturing device, and wherein the training of the neural network is performed at a computing device different from the digital image capturing device.

10. A computer-implemented method of applying a trained neural network for image processing, comprising:
receiving, by a computing device, input raw image data arranged in a color filter array, wherein the color filter array corresponds to an arrangement of color filters on a grid of photosensors corresponding to a camera sensor;
applying, by the computing device, the trained neural network for image processing, the neural network having been trained by:
aligning a stride of an input receptive field of the input layer of the neural network to match an input grid stride for the color filter array for the input raw image data, wherein the stride of the input receptive field corresponds to a number of pixel shifts over the color filter array, and
performing, based on the aligned stride, the image processing on a plurality of images of a training dataset, wherein each image of the plurality of images comprises image data in the color filter array;
performing the image processing on the input raw image data based on the aligned stride of the input receptive field; and
providing, by the computing device, the output of the image processing on the input raw image data.

11. The computer-implemented method of claim 10, wherein the neural network having been trained by:
receiving, by the input layer of the neural network, a pre-training dataset comprising a plurality of images, wherein each image of the plurality of images comprises image data in an initial color system; and
generating, by the input layer of the neural network, the training dataset from the pre-training dataset, wherein the generating comprises converting each image of the plurality of images to a respective image comprising image data arranged in the color filter array.

12. The computer-implemented method of claim 10, wherein the aligning of the stride further comprises:
initializing the input receptive field of the input layer of the neural network at a first position of the input grid stride of the color filter array.

13. The computer-implemented method of claim 10, wherein the color filter array comprises a 2×2 Bayer arrangement of color filters, and wherein the stride of the input receptive field is 2.

14. The computer-implemented method of claim 10, wherein the color filter array comprises a 4×4 Quad Bayer arrangement of color filters, and wherein the stride of the input receptive field is 4.

15. The computer-implemented method of claim 10, wherein the stride of the input receptive field is a multiple of the input grid stride of the color filter array.

16. The computer-implemented method of claim 10, further comprising:
detecting a region of interest in the input raw image data, and
wherein the performing of the image processing is based on the detected region of interest.

17. The computer-implemented method of claim 16, further comprising:
cropping a portion of the input raw image data, wherein the cropped portion comprises the detected region of interest, and wherein the cropping of the portion is aligned to match the grid stride for the color filter array, and
wherein the aligning of the stride comprises aligning the stride of the input receptive field of the input layer of the neural network to match a grid stride for the color filter array for the cropped portion.

18. The computer-implemented method of claim 10, wherein the grid of photosensors corresponding to the camera sensor are part of a digital image capturing device, and wherein the training of the neural network is performed at the digital image capturing device.

19. The computer-implemented method of claim 10, wherein the grid of photosensors corresponding to the camera sensor are part of a digital image capturing device, and wherein the training of the neural network is performed at a computing device different from the digital image capturing device.

20. The computer-implemented method of claim 10, wherein the computing device comprises a digital image capturing device, and wherein the receiving of the input raw image data comprises:
receiving, by the computing device, the input raw image data from the digital image capturing device.

21. The computer-implemented method of claim 10, wherein the computing device comprises a digital image capturing device, and wherein the receiving of the input raw image data comprises:
capturing, by the computing device, an image, and wherein the input raw image data is based on the captured image.

22. The computer-implemented method of claim 10, further comprising:
obtaining the trained neural network at the computing device, and
wherein the performing of the image processing on the input raw image data by the computing device is performed using the trained neural network.

23. A computing device, comprising:
one or more processors; and
data storage, wherein the data storage has stored thereon computer-executable instructions that, when executed by the one or more processors, cause the computing device to carry out functions comprising:
receiving, by the computing device, input raw image data arranged in a color filter array, wherein the color filter array corresponds to an arrangement of color filters on a grid of photosensors corresponding to a camera sensor;
applying, by the computing device, the trained neural network for image processing, the neural network having been trained by:
aligning a stride of an input receptive field of the input layer of the neural network to match an input grid stride for the color filter array for the input raw image data, wherein the stride of the input receptive field corresponds to a number of pixel shifts over the color filter array, and
performing, based on the aligned stride, the image processing on a plurality of images of a training dataset, wherein each image of the plurality of images comprises image data in the color filter array;
performing the image processing on the input raw image data based on the aligned stride of the input receptive field; and
providing, by the computing device, the output of the image processing on the input raw image data.

24. (canceled)

25. (canceled)

26. (canceled)

27. (canceled)
